(19) United States
(12) Patent Application Publication
(10) Pub. No.: US 2026/0198506 A1
(43) Pub. Date: Jul. 16, 2026

(54) Broad-Spectrum Organic Fungicide & Bactericide

(71) Applicant: Ecolution.AG LLC, Temple Terrace, FL (US)

(72) Inventor: Albert Santosh Kumar, Bangalore (IN)

(21) Appl. No.: 19/563,280

(22) Filed: Mar. 11, 2026

Related U.S. Application Data
(63) Continuation of application No. 17/385,515, filed on Jul. 26, 2021, now abandoned.

(30) Foreign Application Priority Data
Jul. 31, 2020 (CA) 3088670

(51) Int. Cl. A01N 65/20; A01N 25/02; A01N 25/30; A01N 65/40; A01N 65/42; A01P 3/00

(52) U.S. Cl. CPC A01N 65/20; A01N 25/02; A01N 25/30; A01N 65/40; A01N 65/42; A01P 3/00

(57) ABSTRACT

A broad-spectrum organic fungicidal composition comprising: aqueous hibiscus leaf extracts ranging in concentration from 2% to 40% w/vol, and acts as a natural surfactant; and Karanja oil (Pongamia Oil) and comprising Karanjin and ranging in concentration from 0.01% to 30% w/v and Karanjin content ranging in concentration from 0.001 to 3% w/vol. alone or in combination with organic compounds mentioned herein.

### CROSS REFERENCES TO RELATED APPLICATION

This application is a continuation of U.S. patent application Ser. No. 17/385,515, filed on Jul. 26, 2021 (US Publication No. US 2022-0030881-A1 issued on Feb. 3, 2022), which claims the benefit of and priority to Canadian Patent Application No. 3,088,670, filed Jul. 31, 2020. The entire specification of the above-referenced application is hereby incorporated, in their entirety by reference.

### FIELD OF THE INVENTION

The present invention is a novel agricultural input created to treat and/or prevent fungal and bacterial diseases more specifically, to the treatment or management of various diseases by an organic fungicide.

### BACKGROUND OF THE INVENTION

The most common and dreadful diseases in Banana are Black and Yellow Sigatoka which occurs on banana leaves almost throughout the year in countries where high humidity and rainfall favour the multiplication of the disease. This disease brings about a yield loss of more than 38% and this makes the banana growers to spray toxic fungicides almost every week once, till harvest.

Another fungal disease which is a major threat to the banana industry as a whole is Panama wilt or Fusarium wilt. This disease is a global threat to banana crops at the present moment as it causes a yield loss of nearly 30% and there are no known fungicides to manage this deadly disease.

Early blight is one of the most common tomato diseases, occurring nearly every season wherever tomatoes are grown. It affects leaves, fruits and stems and can be severely yield limiting when susceptible cultivars are used and weather is favourable. Severe defoliation can occur and result in sunscald on the fruit. Early blight is common in tomato crops but also in several other crops including but not limited to onion plants, potato, corn, chestnut trees, citrus trees, pear trees, apple trees and raspberry plants, wheat.

In tomatoes, early blight can be caused by two different closely related fungi, Alternaria tomatophila and Alternaria solani. Both pathogens are also found to be capable of infecting potato plants. Eggplants are also prone to blight infections.

The presence of blight is identified by the presence on the leaves of a plant of small dark spots which form on older foliage near the ground. The smaller leaf spots are round, brown and can grow up to half inch in diameter while larger spots have target-like concentric rings. The tissue around spots often turns yellow. As the disease progresses, more severely infected leaves turn brown and fall the plant, or dead leaves remain clinging on the stem.

Typical of early blight stem infection is the present of brown stems on seedlings around the soil line. The stem has a brown and dry appearance which is often referred to as collar rot. If the infection is sufficiently severe it will girdle the stem and lead to wilting and death of the seedling. The fruit can be infected by blight at any stage of maturity. Symptoms of blight on a fruit are indicated typically by spots on the fruit which are leathery and black, with raised concentric ridges. The pathogen causing blight can survive on tomato seed and/or may be introduced on tomato transplants. Blight spreads from plant to plant quite easily by coming into direct contact with contaminated soil, or indirectly through rain-splashed soil. Spores can also be spread throughout a field by wind, human contact or equipment, resulting in the potential for recurring infections within a single year.

There are a several common fungicides for the control of early blight on species such as tomatoes. The active ingredient include the following: Mancozeb and Zoxamide; Difenoconazole and Cyprodinil; Azoxystrobin; Fenamidone; Boscalid; Pyraclostrobin; and Penthiopyrad, to name a few. While they show good activity many of these compounds show signs of increasing insensitivity because of a built up resistance which has been observed in regards of usage of chemicals over long term. This combined with their potentially toxic effects for humans upon exposure and/or application renders them less desirable than a natural-based option.

In light of the prior art, there exists a clear need for a fungicide which does not have the drawbacks of currently available fungicides to help in the fight against various diseases including but not limited to blight disease, black sigatoka, fusarium wilt. Fruit and vegetable crops from around the world are essential to the entire world and, as such, it is paramount to develop fungicide and bactericide which will protect those crops. Its significance is even greater in countries where such crops are grown and they are staples of the diet of the population. Such widespread and difficult to control diseases have an immediate and critical impact on those people and as such a better method to control this fungus is required and long overdue.

### SUMMARY OF THE INVENTION

According to a first aspect of the present invention, there is provided a broad-spectrum organic formulation which works on a number of plants fungal and bacterial diseases.

According to a preferred embodiment of the present invention, the composition comprises a surfactant comprising aqueous hibiscus leaf extracts ranging in concentration from 2% to 40% w/v. The hibiscus leaf extract is desirable as it is a natural surfactant. More preferably, the surfactant is present in a concentration ranging from 2% to 30%.

According to another aspect of the present invention, there is provided a fungicidal and/or bactericidal composition comprising Karanja oil (Pongamia Oil) and contains Karanjin and ranging in concentration from 0.001% to 30% w/v and Karanjin content ranging in concentration from 0.001 to 5%. More preferably, the Karanjin component is present in a concentration ranging from 0.01 to 3.0%, 4.

According to another preferred embodiment of the present invention, the composition comprises Karanja oil present in an amount ranging from 1 to 5 wt % of the total weight of the composition.

According to a preferred embodiment of the present invention, the composition further comprises a citrate component selected from the group consisting of: potassium citrate; aluminium citrate; diammonium citrate; ferric citrate; magnesium citrate; monosodium citrate; zinc citrate; citric acid or any other natural form of citric acid ranging in concentration between 2% and 40% by w/v. More preferably, the citrate component is present in a concentration ranging from 10 to 40%.

According to a preferred embodiment of the present invention, the composition further comprises a combination of all acetate salts like ammonium acetate or potassium acetate or Zinc acetate or Aluminium acetate or acetic acid and ranging in concentration from 2.5% to 90% w/vol. More preferably, the acetate component is present in a concentration ranging from 10 to 40% w/vol.

According to a preferred embodiment of the present invention, the composition further comprises fermented aloe vera extracts and it is specially fermented, extracted process and ranging in concentration from 2% to 25% w/vol. More preferably, the fermented aloe vera extracts is present in a concentration ranging from 2 to 20% w/vol.

According to a preferred embodiment of the present invention, the composition further comprises at least one propionate/propionic acid compound selected from the group consisting of: ammonium propionate; calcium propionate; magnesium propionate; potassium propionate; sodium propionate propionic acid and combinations thereof. Preferably the propionate/propionic acid compounds are present in a concentration ranging from 1% to 90% w/vol of the composition. Such compounds have demonstrated some efficacy as antibacterial and as preservative.

According to a preferred embodiment of the present invention, the composition further comprises tartaric acid or a salt thereof selected from the group consisting of: cream of tartar (potassium bitartrate); rochelle salt (potassium sodium tartrate); antimony potassium tartrate and tartaric acid and combinations thereof. Preferably, the tartaric acid or a salt thereof is present in a concentration ranging from 0.05% to 30% w/vol. The tartaric acid or salt thereof has demonstrated some efficacy as an antioxidant and a synergist in the compositions according to the present invention.

According to a preferred embodiment of the present invention, the composition further comprises succinic acid or a derivative thereof such as sodium succinate (anhydrous) that is the disodium salt of succinic acid. Preferably, the succinic acid or a derivative thereof is present in a concentration ranging from 0.02% to 10% w/vol. Such compounds have demonstrated some efficacy as stabilizer in formulations.

According to a preferred embodiment of the present invention, the composition further comprises malic acid in a concentration ranging from 0.002% to 30% w/vol. More preferably, the malic acid is present in a concentration ranging from 5% to 20%. Such compounds have demonstrated some efficacy in enhancing formulations by acting as a synergist.

According to a preferred embodiment of the present invention, the composition further comprises a lactate component selected from the group consisting of: sodium lactate; calcium lactate; potassium lactate; and lactic acid and ranging in concentration from 1% to 90% w/vol. More preferably, the lactate component is present in a concentration ranging from 5% to 40%. Such compounds have demonstrated some efficacy as a preservative and a synergist.

According to a preferred embodiment of the present invention, the composition further comprises a combination of shikimic acid or ferulic acid or benzoic acids or their salts or esters and ranging in concentration from 0.05% to 30% w/vol. Shikimic acid is also the glycoside part of some hydrolysable tannins. The acid is highly soluble in water and insoluble in nonpolar solvents, and this is why shikimic acid is active only against Gram-positive bacteria, due to outer cell membrane impermeability of Gram-negatives. Such compounds have demonstrated some efficacy as an anti-bacterial and a synergist in the formulation.

According to a preferred embodiment of the present invention, the composition further comprises formic acid ranging in concentration from 5% to 30% w/vol. Formic acid has preservative and anti-bacterial properties.

According to a preferred embodiment of the present invention, the Karanja oil is present in an amount ranging from 1 to 5 wt. %. Preferably also, the fermented aloe vera extracts are present in an amount ranging from 40 to 60 wt. %. Preferably, the natural surfactant is present in an amount ranging from 30 to 60 wt. %. More preferably, the natural surfactant is present in an amount ranging from 35 to 45 wt %.

According to another aspect of the present invention, there is provided a method for the prevention, treatment and/or management of the black sigatoka on plants prone to such fungus, said method comprising the steps of:
providing a fungicidal composition comprising Karanja oil;
applying said composition on said plants;
wherein said step of applying is repeated as necessary and can be done until the day before harvest.

According to another aspect of the present invention, there is provided a method for the stimulation of the growth of a plant prone to the fungus black sigatoka, said method comprising the steps of:
providing a fungicidal composition comprising Karanja oil;
applying said composition on said plants;
wherein said step of applying is repeated as necessary and can be done until the day before harvest.
Preferably, said composition further comprises fermented aloe vera extracts. Preferably also, said composition further comprises a natural surfactant. Preferably also, said composition further comprises water as a solvent.

According to a preferred embodiment of the present invention, the composition has both anti-fungal properties and growth stimulating properties, which while increasing the growth of the plant and it has also shown to be capable to increase the plant survival rate to almost 95%.

### DESCRIPTION OF THE INVENTION

Organic food is defined by The Department for Agriculture and Rural Affairs (DEFRA) as: ‘Organic food is the product of a farming system which avoids the use of man-made fertilisers, pesticides; growth regulators and livestock feed additives. Irradiation and the use of genetically modified organisms (GMOs) or products produced from or by GMOs are generally prohibited by organic legislation.’

Organic agriculture is similarly defined by DEFRA as: ‘Organic agriculture is a systems approach to production that is working towards environmentally, socially and economically sustainable production. Instead, the agricultural systems rely on crop rotation, animal and plant manures, some hand weeding and biological pest control.’

The Clean Food Standard is a voluntary best-practice standard for food producers aimed at identifying fresh grown foods that meet exceptional standards of product purity. The standard extends the concept of purity embodied in national Clean Air and Clean Water regulations into the food arena. Specifically, the standard addresses four areas of potential concern: 1) pesticide residues, 2) food pathogens, 3) industrial contaminants and heavy metals; and 4) GMOs. The Clean Food Standard is intended to assist commercial, government and institutional buyers as well as consumers make better informed decisions about the fresh grown foods they purchase in terms of product purity considerations, thereby protecting the health and welfare of consumers by limiting their risk of exposure to potentially harmful residues and pathogens in the food supply. The Clean Food Standard is also intended to provide marketplace recognition to food producers who are voluntarily taking exceptional measures to protect the purity of the food they produce, thereby encouraging food producers to adopt pest management regimes, growing practices and food handling methods that minimize potential harm to human health and the environment from pesticide exposure, food pathogens, and other contaminants. Further, the Clean Food Standard is intended to serve as the basis for specific market claims, to be certified by recognized independent third parties who have no ownership or brokerage interest in the foods being certified, and who have no vested interest in the outcome of a given certification. The Clean Food Standard is also intended to define product purity requirements that can be used to inform the development of broader national standards for sustainable agricultural practices.

In light of the Clean Food Standards, the definition of a Clean Food is ‘a fresh grown food product that complies with the requirements set forth in this Standard’. While it is commonplace knowledge that pesticides are used to protect crops against insects, weeds, fungi and other pests. It is also commonplace knowledge that pesticides are potentially toxic to humans and can have both acute and chronic health effects, depending on the quantity and ways in which a person is exposed. Some of the older, cheaper pesticides can remain for years in soil and water. These chemicals have been banned from agricultural use in developed countries, but they are still used in many developing countries. The greatest dirty secret of pesticides and fungicides is that the people who face the greatest health risks from exposure to pesticides are those who come into contact with them at work, in their home or garden.

The “limit of detection” (LOD) is the limit below which a laboratory cannot confirm the presence of a specific residue in a given commodity. For pesticides, LODs are established in accordance FDA PAM II protocols for pesticides. For heavy metals, LODs are established in accordance with EPA protocols for ICP-MS. For other industrial chemicals, LODs are established in accordance with EPA 600-series protocols. The purity requirements of a Clean Food include synthetic pesticides with US EPA tolerances. Therefore, a clean food product shall be shown to be free of pesticide residues based on LODs for all registered synthetic pesticides with established tolerances. For those crops that have a pulp-only tolerance (e.g., honeydew, cantaloupe, banana), or for those crops that are tested for edible portion only in accordance with FDA PAM II protocols (e.g., corn, avocado), only the edible portion shall be required to be free of pesticide residues, based on the laboratory LOD. By or before 2010, all LODs must, at a minimum, meet de minimus risk levels.

In Canada, the maximum residue limit for pesticides is assessed by considering that the residue definition upon which maximum residue limits (MRLs) are based typically includes the parent chemical and often includes corresponding metabolites. In some cases, a chemical may have multiple residue definitions, for example, between food crops and livestock commodities. The residue definition for all chemicals with established MRLs regulated under the Pest Control Products Act are listed in a table which reflects the content previously found in MRL listings under “Chemical Name of Substance”. MRLs established in Canada may be found using the Maximum Residue Limit Database on the Maximum Residue Limits for Pesticides webpage. The database allows users to search for established MRLs, regulated under the Pest Control Products Act, both for pesticides or for food commodities. There are over 400 chemicals listed on the Canadian website which produce at least one metabolite which can be of concern upon consumption of a foodstuff containing such.

According to a first aspect of the present invention, there is provided abroad spectrum organic formulation which works on a number plant fungal and bacterial diseases.

The inventors have unexpectedly found that a composition comprising Karanja oil, hibiscus leaf extract and fermented extracts of aloe vera provided surprising control and management of the black sigatoka on banana tree leaves. In fact, upon testing a composition according to a preferred embodiment of the present invention it was determined that 95% of the trees had no traces of black sigatoka fungus on their leaves. The advantages of such a composition are substantial given the increasing environmental regulations prohibiting or severely limiting the use of synthetic fungicides such as those mentioned previously. Not only are synthetic fungicides inherently dangerous when it comes to consumption but they also pose a great threat to waterways as well as the soil on which they end up. In certain countries, regulations do not permit the use of synthetic fungicides within 60 feet of any roadways and in some cases also 60 feet from any waterway. When taking this into account there is a clear disadvantage for even a small farmer of utilizing such pesticides as the restrictions prevent the cultivation of large tracts of land.

Because the compositions according to a preferred embodiment of the present invention, are not synthesized by man, such environmental restrictions do not apply. In fact, the natural origination of the components of a preferred embodiment of the present invention allows it to be used in substantially all of the possible cultivation areas in the world. Moreover, as it does not fall under the definition of synthetic fungicide, the use thereof would allow the cultivation of plants beyond the 60-foot limit enacted by regulations. Hence, plants can be cultivated closer to roads and waterways without negatively impacting the environment as all the components are naturally sourced.

Karanjin is a furanoflavonol, a type of flavonoid obtained from the seeds of the Karanja tree, a wild tree native to southern India. It is widespread and is an important source of bio-fuel as a substitute for diesel and to run power grid systems to run water pumps. Karanja is known as an herbal medicine mostly used for the treatment of skin diseases. According to a preferred embodiment of the present invention, Karanjin is present in an amount ranging from 1 to 5 wt % of the total weight of the composition. Preferably, it is present in an amount ranging from 1 to 3 wt % and even more preferably, from 1 to 2 wt %. A most preferred composition comprises Karanjin at 1.37 wt %. According to another aspect of the present invention, there is provided a fungicidal and bactericidal composition comprising Karanja oil (Pongamia Oil) and contains Karanjin and ranging in concentration from 0.01% to 30% w/v and Karanjin content ranging in concentration from 0.001 to 3.0%.

According to a preferred embodiment of the present invention, a composition comprising Karanja oil, hibiscus leaf extract and fermented extracts of aloe vera was found to show substantial fungicidal activity against a number of crop diseases.

Fermented extracts of aloe vera can be obtained by fermenting the flesh of the plant. This yields among other compounds, lactic acid bacteria (LAB) which have antimicrobial activity. According to a preferred embodiment of the present invention, the combination of Karanja oil and fermented extracts of aloe vera yields a potentiated fungicidal composition which has a particular affinity for the reduction, control, management and/or eradication of black sigatoka fungus. Hence, applying a preferred composition of the present invention to banana tree leaves would help in eliminating or at least substantially minimizing the presence of such fungus. In large monoculture farms, this composition would represent a number of advantages. It would eliminate the need to monitor water discharges of synthetic fungicides, as it is made with natural products. It also allows using a greater part of the potential arable surface area as it is not affected by the environmental restrictions applicable to synthetic fungicides. Advantageously, as the composition according to a preferred embodiment of the present invention is an organic formulation, it does not leave any residue. After eliminating the fungus in question, the composition's components break down into water, oxygen and carbon dioxide and, as such, make it the best organic fungicide available. Additionally, a preferred embodiment of the present invention has exhibited natural growth enhancing effect by increasing the overall growth of the plant with more pronounced effect seen on the leaves in terms of increased width as well as in length. According to a preferred embodiment of the present invention, the composition further comprises fermented aloe vera extracts and it is specially fermented, extracted process and ranging in concentration from 2% to 25% w/v.

According to a preferred embodiment of the present invention, the surfactant is a naturally occurring surfactant. Preferably, it is a hibiscus leaf extract. The hibiscus leaf extracts has natural surfactants in the form of saponins which act as surfactants to the organic formulation by way of reducing surface tension which enables the product to spread on the leaf surface and make the active ingredient available to act the fungus efficiently. Other naturally occurring compounds deemed to be suitable alternative for hibiscus include soap nuts. Other natural surfactants considered within the scope of the present invention include: coco glucoside, as well as decyl glucoside both derived from natural sources. According to a preferred embodiment of the present invention, the composition comprises a surfactant comprising aqueous Hibiscus leaf extracts ranging in concentration from 2% to 40% w/v. The hibiscus leaf extract is desirable as it is a natural surfactant. More preferably, the surfactant is present in a concentration ranging from 2 to 10%.

According to another preferred embodiment of the present invention, there is provided an organic fungicide with natural growth promoting effect on plants.

According to a preferred embodiment of the present invention, there is provided a composition comprising plant extracts and plant oils as per the following (in wt %):
karanja oil—1.27% (1 to 5%)—the karanjin content in karanja oil is 0.002%
hibiscus leaf extract 38%—(30 to 40%)
aloe vera extracts (fermented) 56.9% (40 to 60%)
water 3.83% (3 to 5%)

According to a preferred method of using the composition, the inventors hypothesize that the mode of action of a composition according to a preferred embodiment of the present invention is by preventing the formation of spores which eventually controls the spread of fungus.

According to another aspect of the present invention, there is provided a food product classified as ‘clean food’ grown in the presence of an aqueous fungicidal composition comprising Karanj oil. Preferably, the composition further comprises fermented aloe vera extracts. Preferably, the composition further comprises fermented aloe vera extracts and a natural surfactant. More preferably, the Karanj oil is present in an amount ranging from 1 to 5 wt % of the total weight of the composition. More preferably, the fermented aloe vera extracts are present in an amount ranging from 40 to 60 wt % of the total weight of the composition. More preferably, the natural surfactant is present in an amount ranging from 30 to 60 wt % of the total weight of the composition. Even more preferably, the natural surfactant is present in an amount ranging from 35 to 45 wt % of the total weight of the composition.

According to another aspect of the present invention, there is provided a food product classified as ‘pesticide residue-free’ (or simply residue-free) grown in the presence of an aqueous fungicidal composition comprising Karanj oil. Preferably, the composition further comprises fermented aloe vera extracts. Preferably, the composition further comprises fermented aloe vera extracts and a natural surfactant. More preferably, the Karanj oil is present in an amount ranging from 1 to 5 wt % of the total weight of the composition. More preferably, the fermented aloe vera extracts are present in an amount ranging from 40 to 60 wt % of the total weight of the composition. More preferably, the natural surfactant is present in an amount ranging from 30 to 60 wt % of the total weight of the composition. Even more preferably, the natural surfactant is present in an amount ranging from 35 to 45 wt % of the total weight of the composition.

According to another aspect of the present invention, there is provided a food product grown with an exposure to an aqueous fungicidal composition comprising Karanj oil. Preferably, the composition further comprises fermented aloe vera extracts. Preferably, the composition further comprises fermented aloe vera extracts and a natural surfactant. More preferably, the Karanj oil is present in an amount ranging from 1 to 5 wt % of the total weight of the composition. More preferably, the fermented aloe vera extracts are present in an amount ranging from 40 to 60 wt % of the total weight of the composition. More preferably, the natural surfactant is present in an amount ranging from 30 to 60 wt % of the total weight of the composition. Even more preferably, the natural surfactant is present in an amount ranging from 35 to 45 wt % of the total weight of the composition.

According to a preferred embodiment of the present invention, the composition further comprises a citrate component selected from the group consisting of: potassium citrate; aluminium citrate; diammonium citrate; ferric citrate; magnesium citrate; monosodium citrate; zinc citrate; citric acid or any other natural form of citric acid ranging in concentration between 2% and 40% by w/v. More preferably, the citrate component is present in a concentration ranging from 10 to 40%. The citrate component has demonstrated enhancement of compositions as well as possessing anti-fungal properties.

According to a preferred embodiment of the present invention, the composition further comprises a combination of all acetate salts like ammonium acetate or potassium acetate or zinc acetate or Aluminium acetate or acetic acid and ranging in concentration from 2.5% to 90% w/vol. More preferably, the acetate component is present in a concentration ranging from 10 to 40% w/vol.

According to a preferred embodiment of the present invention, the composition further comprises at least one propionate/propionic acid compound selected from the group consisting of: ammonium propionate; calcium propionate; magnesium propionate; potassium propionate; sodium propionate propionic acid and combinations thereof. Preferably the propionate/propionic acid compounds are present in a concentration ranging from 1% to 90% w/vol of the composition. Such compounds have demonstrated some efficacy as antibacterial and as preservative.

According to a preferred embodiment of the present invention, the composition further comprises tartaric acid or a salt thereof selected from the group consisting of: cream of tartar (potassium bitartrate); rochelle salt (potassium sodium tartrate); antimony potassium tartrate and tartaric acid and combinations thereof. Preferably, the tartaric acid or a salt thereof is present in a concentration ranging from 0.05% to 30% w/vol. The tartaric acid or salt thereof demonstrated a growth enhancing effects on plants treated with compositions containing such.

According to a preferred embodiment of the present invention, the composition further comprises succinic acid or a derivative thereof such as sodium succinate (anhydrous) that is the disodium salt of succinic acid. Preferably, the succinic acid or a derivative thereof is present in a concentration ranging from 0.02% to 10% w/vol. Such compounds have demonstrated some efficacy as stabilizer in formulations.

According to a preferred embodiment of the present invention, the composition further comprises malic acid in a concentration ranging from 0.002% to 40% % w/vol. More preferably, the malic acid is present in a concentration ranging from 2% to 30%. Such compounds have demonstrated some efficacy in enhancing formulations by acting as a synergist.

According to a preferred embodiment of the present invention, the composition further comprises a lactate component selected from the group consisting of: sodium lactate; calcium lactate; potassium lactate; and lactic acid and ranging in concentration from 1% to 90% w/vol. More preferably, the lactate component is present in a concentration ranging from 5% to 40%. Such compounds have demonstrated some efficacy as a preservative and a synergist.

According to a preferred embodiment of the present invention, the composition further comprises a combination of shikimic acid or ferulic acid or benzoic acids or their salts or esters and ranging in concentration from 0.05% to 30% w/vol. Shikimic acid is also the glycoside part of some hydrolysable tannin. The acid is highly soluble in water and insoluble in nonpolar solvents, and this is why shikimic acid is active only against Gram-positive bacteria, due to outer cell membrane impermeability of Gram-negatives. Such compounds have demonstrated some efficacy as an anti-bacterial and a synergist in the formulation.

According to a preferred embodiment of the present invention, the composition further comprises formic acid ranging in concentration from 0.05% to 30% w/vol. Formic acid has preservative and anti-bacterial properties.

According to a preferred embodiment of the present invention, the composition comprises a component from one or several of the classes enumerated above number in combination with above-mentioned plant extracts and works on all plant fungal and bacterial diseases.

Preferred compositions according to the present invention have been tested on Black & Yellow Sigatoka in Banana, Panama wilt or Fusarium wilt in bananas, bacterial diseases like Erwinia in bananas, Fusarium wilt in tomatoes, tobacco, legumes, cucurbits, sweet potatoes, soybean, and canola.

Preferred compositions according to the present invention have shown effectiveness against early and late blight diseases in a number of crops and vegetables.

Preferred compositions according to the present invention have shown to be effective on powdery mildew and downy mildew diseases of a number of crops and vegetables.

Preferred compositions according to the present invention have shown to be effective on fungal diseases which include, but is not limited to: Anthracnose; Botrytis rots; Rusts; Rhizoctonia rots; Sclerotinia rots and Sclerotium rots.

Preferred compositions according to the present invention have shown to be effective on a number of diseases in Paddy, namely sheath blast, sheath spot, alternaria leaf spot. These diseases can reduce the crop yield by up to 50% as well as affect the quality thereof.

There are over 1000 known pesticides used around the world to protect food crops from damage or destruction by a variety of pests. Each pesticide has different properties and toxicological effects. The toxicity of a pesticide depends on its function and other factors. For example, insecticides tend to be more toxic to humans than herbicides. The same chemical can have different effects at different doses (how much of the chemical a person is exposed to). It can also depend on the route by which the exposure occurs (such as swallowing, inhaling, or direct contact with the skin).

What is less known is that pesticides are among the leading causes of death by self-poisoning, in particular in low- and middle-income countries. Because of their inherent toxicity and due to the fact that they are deliberately spread in the environment, the production, distribution, and use of pesticides require strict regulation and control. Regular monitoring of residues in food and the environment is also required. The most at-risk population are people who are directly exposed to pesticides. This includes agricultural workers who apply pesticides, and other people in the immediate area during and right after pesticides are spread. The general population—who are not in the area where pesticides are used—is exposed to significantly lower levels of pesticide residues through food and water.

Pesticides and fungicides can prevent large crop losses and will therefore continue to play a role in agriculture. However, the effects on humans and the environment of exposure to pesticides are a continuing concern.

It is critical that the use of synthetic chemicals in the assistance of food production be limited as much as possible so that the benefits not only outweigh the inherent risks associated with the use of such products but preferably should provide farmers and people handling such products with a much safer workplace environment (storage, handling, disposal, etc.) than is currently required by the extremely lax regulations in many countries. It is important to be reminded of the fact that the use of pesticides to produce food, both to feed local populations and for export, should comply with good agricultural practices regardless of the economic status of a country. As such, farmers should limit, both for their own safety but also because of their critical contribution to the food chain, the amount of pesticide used to the minimum necessary to protect their crops.

It is also possible, under certain circumstances, to produce food without the use of synthetic pesticides. This is the ideal case, where the farmers can attend to their crops safely while being capable of producing large amounts of food both for their own families, for transactions in the local market as well as for exporting to other countries.

According to a preferred embodiment of the present invention, the composition is sprayed on the ground close to a banana tree plant so as to soak the roots and prevent/reduce/destroy the presence of fusarium wilt on the plant. Preferably, the product is drenched around the root zone to manage the plant disease. It is hypothesized by the inventors that the mode of action of a composition according to a preferred embodiment of the present invention is by preventing the formation of spores and eventually the spread of fungus is managed.

According to a preferred embodiment of the present invention, the use composition will produce a food product classified as ‘clean food’.

According to a preferred embodiment of the present invention, the use composition will produce a food product classified as ‘pesticide residue-free food’ or ‘residue-free product’ or ‘residue-free food product’.

According to another aspect of the preferred embodiment of the present invention, there is provided a food product classified as ‘clean food’ grown in the presence of an aqueous fungicidal composition comprising Karanj oil. Preferably, the composition further comprises fermented aloe vera extracts. Preferably also, the composition further comprises fermented aloe vera extracts and a natural surfactant. According to a preferred embodiment of the present invention, the Karanj oil is present in an amount ranging from 1 to 5 wt % of the total weight of the composition. According to a preferred embodiment of the present invention, the fermented aloe vera extracts are present in an amount ranging from 40 to 60 wt % of the total weight of the composition. According to a preferred embodiment of the present invention, the natural surfactant is present in an amount ranging from 30 to 60 wt % of the total weight of the composition. According to a preferred embodiment of the present invention, the natural surfactant is present in an amount ranging from 35 to 45 wt % of the total weight of the composition.

According to another aspect of the preferred embodiment of the present invention, there is provided a food product classified as ‘residue-free’ grown in the presence of an aqueous fungicidal composition comprising Karanj oil. According to a preferred embodiment of the present invention, the composition further comprises fermented aloe vera extracts. According to a preferred embodiment of the present invention, the composition further comprises fermented aloe vera extracts and a natural surfactant.

Preferably, the Karanj oil is present in an amount ranging from 1 to 5 wt % of the total weight of the composition. Preferably, the fermented aloe vera extracts are present in an amount ranging from 40 to 60 wt % of the total weight of the composition. Preferably, the natural surfactant is present in an amount ranging from 30 to 60 wt % of the total weight of the composition. Preferably, the natural surfactant is present in an amount ranging from 35 to 45 wt % of the total weight of the composition.

According to another aspect of the preferred embodiment of the present invention, there is provided a food product grown with an exposure to an aqueous fungicidal composition comprising Karanj oil. Preferably, the composition further comprises fermented aloe vera extracts. Preferably, the composition further comprises fermented aloe vera extracts and a natural surfactant. Preferably, the Karanj oil is present in an amount ranging from 1 to 5 wt % of the total weight of the composition. Preferably, the fermented aloe vera extracts are present in an amount ranging from 40 to 60 wt % of the total weight of the composition. Preferably, the natural surfactant is present in an amount ranging from 30 to 60 wt % of the total weight of the composition. Preferably, the natural surfactant is present in an amount ranging from 35 to 45 wt % of the total weight of the composition. Preferably, the food product is selected from a group consisting of: tomato, tobacco, legumes, cucurbits, sweet potatoes, soybean, and canola.

### Example 1—Liquid Composition

To make a 5 litre solution of a preferred composition according to the present invention, one combines 1.40 kg of lactic acid, 1.10 kg of propionic acid, 1.5 kg of aqueous hibiscus extracts blended with 9.51 grams of Karanja oil, followed by blending with 1.0 kg of fermented aloe vera extracts.

### Example 2—Solid Composition

To make a 5 kg sample of powder of a composition according to a preferred embodiment of the present invention, one combines: 5 grams of organic surfactants mixed with 1500 grams of citric acid, 1500 grams of tartaric acid, 950 grams of malic acid, 975 grams of oxalic acid and finally blended with 60 grams Aloe vera spray dried powder and 10 grams of spray dried Karanja oil once all ingredients are combined, mixing is continued until the composition provides an homogenous appearance.

### Example 3—Iceberg Lettuce Rot Management Trials

A composition according to a preferred embodiment of the present invention (composition of Example 1) was tested on a plot of iceberg lettuce to evaluate its effectiveness against pathogens such as Fusarium sp., Pythium sp., Alternaria sp., Mycospharella sp. and others affecting iceberg lettuce crops.

The composition was applied by spraying onto the lettuce in a concentration of 5 ml of stock solution (Example #1) to every liter of water. The product is that much more desirable as it readily mixes with water and its necessary concentration is quite low.

Lettuce seedlings (17,500) were transplanted into a field and the trial composition was sprayed onto 6000 seedlings/lettuce plants on three occasions, at 25 days after transplant, at 37 days after transplant and at 49 days after transplant.

After the first spraying, neither plots showed any rotting on the plants. After the second spraying, the trial plot had 6 of 50 plants showing signs of rot, while the control plot had 22 of 50 plants showing signs of rot. After the third spraying, the trial plot had 17 of 50 plants showing signs of rot with 60% of the plant having heavy spots on the leaves, while the control plot had 31 of 50 plants showing signs of rot with 80% of the plant having heavy spots on the leaves. The yield of the control plot and the trial plot were measured and are presented in Table 1 below.

TABLE 1
Summary of the Yield of the Lettuce plots
in the Trial #1 on Lettuce Rot management

| | Control plot | Trial Plot |
|---|---|---|
| No of seedlings | 11,500 | 6,000 |
| Harvested quantity | 3167 kg/364 crates | 2396 kg/283 crates |
| Productivity/acre | 6884 kg/acre | 9983.3 kg/acre |

The use of the composition according to a preferred embodiment of the present invention was clearly superior to the control plot as it the productivity per acre was increased by 3099.3 kg which is an increase of 45%. Both lettuce plots had leaf drop issues and leaf spot issues. The trial plot had substantially less drop issue than the control plot. Both plots had leaf necrosis at the maturity stage. It is worth noting that the seedlings from the control and trial plots had leaf issues at the moment of transplantation and thus were both sprayed by chlorthalonil at the initial stage.

In a second trial, lettuce seedlings (23,000) were transplanted into a field and the trial composition was sprayed onto 12,000 seedlings/lettuce plants on three occasions, at 25 days after transplant, at 37 days after transplant and at 49 days after transplant. The yield of the control plot and the trial plot were measured and are presented in Table 2 below.

TABLE 2
Summary of the Yield of the Lettuce plots
in the Trial #2 on Lettuce Rot management

| | Control plot | Trial Plot |
|---|---|---|
| No of seedlings | 11,000 | 12,000 |
| Harvested quantity | 1118 kg/80 crates | 3874 kg/372 crates |
| Productivity/acre | 2540 kg/acre | 8070 kg/acre |

While rotting was found to be present in both the control plot and in the trial plot, the difference in yield was substantial, where the trial plot yielded over three times more lettuce than the control plot. In Trial #2, the control plot was treated with a common chemical fungicide.

### Example 4—Treatment of Fusarium Wilt in Banana Plants

Fusarium wilt infected banana plants were treated with a composition according to a preferred embodiment of the present invention (Example #1) and were found to be substantially free of fusarium wilt 16 days after being initially treated with the composition. The composition was made according to Example 1 and 10 ml of the stock solution (Example 1) were diluted in 2 litres of water and then drenched around the root zone of infected banana plants.

### Example—5 Treatment of Black Sigatoka and Yellow Sigatoka in Banana Plants

Healthy banana plants were treated with a composition according to a preferred embodiment of the present invention and were found to maintain the plant free of both Black Sigatoka and Yellow Sigatoka for the duration of the growing season.

Where banana plants were already infected with either Black Sigatoka or Yellow Sigatoka, the fungus was controlled and reduced by spraying every week once at a concentration of 3 to 5 ml/litre on the leaf surface.

### Example 6—Bitter Gourd

Similar results were obtained on bitter gourd which were affected by a leaf disease which caused yellow browning of the leaf. The more advanced diseased areas on the leaves exhibited browning coloration on the leaf. Treatment with the composition according to a preferred embodiment of the present invention was found to substantially reduce the appearance of the yellow spots on the leaves.

### Example 7—Ridge Gourd

Similar results were obtained on ridge gourd which were affected by a leaf disease which caused yellow browning of the leaf as well as a grey musty deposit on the leaves. Treatment with the composition according to a preferred embodiment of the present invention was found to substantially reduce the appearance of the yellow spots and the musty deposit on the leaves.

### Example 8—Powdery Mildew on Grapes

Grape vines affected by powdery mildew were similarly treated with the composition according to a preferred embodiment of the present invention. Treatment with the composition according to a preferred embodiment of the present invention was found to substantially reduce the presence of powdery mildew on both the grapes and the leaves of the grapevine.

### Example 9—Powdery Mildew on Watermelons

Watermelon plants affected by powdery mildew were similarly treated with the composition according to a preferred embodiment of the present invention. Treatment with the composition according to a preferred embodiment of the present invention was found to substantially reduce the presence of powdery mildew on both the leaves and stems of the watermelon plants.

### Example 10—Anthracnose on Broad Beans

Broad bean plants were sprayed with a composition according to a preferred embodiment of the present invention. After appearance of the disease, the treatment managed/eliminated the disease upon regular application. Before the appearance of the disease, the application prevented the disease from infecting the plants.

### Example 11—Anthracnose on Chili Peppers

Chili pepper plants were sprayed with a composition according to a preferred embodiment of the present invention. After appearance of the disease, the treatment managed/eliminated the disease upon regular application. Before the appearance of the disease, the application prevented the disease from infecting the plants.

### Example 12—Anthracnose and Powdery Mildew in Mango Plants

Mango plants were sprayed with a composition according to a preferred embodiment of the present invention. After appearance of the disease, the treatment managed/eliminated the disease upon regular application.

### Example 13—Cercospora Leaf Spot on Beetroot

Beetroot plants were sprayed with a composition according to a preferred embodiment of the present invention. After appearance of the disease, the treatment managed/eliminated the disease upon regular application.

### Example 14—Erwinia Bacterial Disease in Banana Plants

15 to 18 days after the treatment with a preferred composition according to the present invention on banana plants infected with erwinia bacterial disease the banana plants showed substantially full recovery with green leaves devoid of spots characteristic with erwinia bacterial disease and the corm becomes disease free and thus capable of bearing the weight of the plant.

### Example 15—Downy Mildew on Tomato Plants

Tomato plants affected by downy mildew were similarly treated with the composition according to a preferred embodiment of the present invention. Treatment with the composition according to a preferred embodiment of the present invention was found to substantially reduce the presence of downy mildew on the leaves of the tomato plants to an extent where prior infection was unnoticeable.

### Example 16—Leaf Blight on Tomato Plants

Tomato plants were sprayed with a composition according to a preferred embodiment of the present invention. After appearance of the disease, the treatment managed/eliminated the disease upon regular application. Before the appearance of the disease, the application prevented the disease from infecting the plants.

### Example 17—Early Blight on Onion Plants

Onion plants were sprayed with a composition according to a preferred embodiment of the present invention. After appearance of the disease, the treatment managed/eliminated the disease upon regular application.

### Example 18—White Rot on Onion Plants

Onion plants were sprayed with a composition according to a preferred embodiment of the present invention. After appearance of the disease, the treatment managed/eliminated the disease upon regular application.

### Example 19—Pythium Root Disease on Cucumber Plants

Cucumber plants affected by Pythium root disease were similarly treated with the composition according to a preferred embodiment of the present invention. Treatment with the composition according to a preferred embodiment of the present invention was found to substantially reduce the wilting of the leaves to an extent where prior infection was unnoticeable. Treatment consisted in the application of 100 ml of the composition (0.5% concentration). Comparative treatment with a synthetic fungicide (Pervicur® by Bayer) did not result in overcoming the wilting of the leaves.

### Example 20—Phomopsis Blight on Brinjal (eggplant)

Eggplants were sprayed with a composition according to a preferred embodiment of the present invention. After appearance of the disease, the treatment managed/eliminated the disease upon regular application.

According to a preferred embodiment of the present invention, the composition has both anti-fungal properties and growth stimulating properties, which while increasing the growth of the plant and it has shown to increase the plant survival rate to almost 95%.

There are no known major fungicidal products which effectively manage Fusarium wilt in bananas. The economic impact caused by fusarium wilt is quite large and it leads to losses in the hundreds of millions of dollars per year. The composition according to a preferred embodiment of the present invention, costs less than synthetic fungicides and has practically no after-market costs (no clean-up costs, no lawsuits because of toxicity unlike some synthetic products, no water discharge control measures necessary, greater proportion of the land can be used, etc.). Moreover, it manages the disease effectively and has an added advantage of accelerating the growth of banana tree plants. It has been reported that the use of a composition according to the present invention has increased the yield of each banana tree by up to 20-25% more bananas as well as providing larger bananas than untreated or plants treated with chemical pesticides.

Even organic bananas, which are grown using the organic guidelines can be treated with synthetic fungicide. The rules of application require covering the banana fruits with a bag and interrupting the spraying of the fungicide at least 14 days prior to the harvest. Moreover, it is important to note that despite the ‘organic’ labelling the produce may still be exposed to synthetic fungicide (i.e. not even covered by a bag).

According to a preferred embodiment of the present invention, the application of a composition of the present invention would allow a farmer to apply said composition on the bananas without having to cover them in a plastic bag. This has a three-fold advantage, less workforce necessary to cover the banana plants, no usage of plastic bags and subsequent disposal thereof and maintaining a ‘clean food’ labelling standard.

According to a preferred embodiment of the present invention, the application of a composition of the present invention would allow a farmer to have fewer dead banana tree leaves. Dead leaves due to infection from a fungi must be removed quickly to prevent the spreading of the fungal infections to other leaves and ultimately to the entire plant. The fact that such a composition provides the farmer with such an outstanding performance against fungal infections would allow him to employ fewer people whose sole job is to walk up and down the banana grove and cutting off infected leaves.

According to a preferred embodiment of the present invention, the composition has no specific disadvantages in comparison to the synthetic fungicides being currently used. Nonetheless, it is preferable to take care when using the fungicide according to a preferred embodiment on plants by using appropriate eye protection and nose masks to prevent any potential damage.

### Flesh Testing of Fungicide

Testing to determine the absorption of fungicide into the flesh of bananas was conducted in order to eventually determine whether a natural fungicide would avoid such drawback. Testing was conducted at the University of Guelph Agriculture and Food Laboratory in order to assess the pesticide and fungicide content of a variety of bananas obtained on the shelves of a Canadian supermarket.

Bananas obtained from six different sources (3 regulars and 3 organics) are labelled as #1 to #3 (for both regular and organic sources). The first series of testing involved assessing the content of ethylenebisdithiocarbamates (EBDC) in the flesh of the bananas purchased. Table #1 provides a summary of the results from the testing.

TABLE #1
Results of testing of banana flesh
for presence of EBDC compounds

| Sample | Test | Results |
|---|---|---|
| Banana #1 | EBDC Screen | Detected |
| | | (ethylenebisdithiocarbamates |
| | | <MQL) |
| Banana #2 | EBDC Screen | Detected |
| | | (ethylenebisdithiocarbamates |
| | | <MQL) |
| Banana #3 | EBDC Screen | Not detected |
| Banana (organic #1) | EBDC Screen | Not detected |
| Banana (organic #2) | EBDC Screen | Not detected |
| Banana (organic #3) | EBDC Screen | Not detected |

EBDC's are measured as CS2 and reported as Zineb equivalent.
EBDC MDL = 0.03 ppm, MQL = 0.05 ppm

The second series of testing by GC-MS/MS multiresidue screen (Method ID: TOPS-142) was done to assess the presence of pesticides (as well as their content and identity) in the flesh of the bananas purchased. Table #2 provides a summary of the results from the testing.

TABLE #2
Results of testing of banana flesh for presence of pesticides using
a GC-MS/MS multiresidue screen (Method ID: TOPS-142)

| Sample | Test | Results |
|---|---|---|
| Banana #1 | Pesticide screen | Detected |
| Banana #1 | Chlorpyrifos | <MQL |
| Banana #1 | Myclobutanil | 0.040 ppm |
| Banana #1 | Azoxystrobin | 0.042 ppm |
| Banana #1 | bifenthrin | <MQL |
| Banana #2 | Pesticide screen | Detected |
| Banana #2 | Chlorpyrifos | 0.011 ppm |
| Banana #2 | Azoxystrobin | 0.0094 ppm |
| Banana #2 | bifenthrin | <MQL |
| Banana #3 | Pesticide screen | Detected |
| Banana #3 | Myclobutanil | 0.089 ppm |
| Banana #3 | Azoxystrobin | 0.034 ppm |
| Banana #3 | bifenthrin | 0.073 ppm |
| Banana (organic #1) | Pesticide screen | Not detected |
| Banana (organic #2) | Pesticide screen | Not detected |
| Banana (organic #3) | Pesticide screen | Detected |
| Banana (organic #3) | Tebuconazole | <MDL |
| Banana (organic #3) | chlorpyrifos | <MDL |

Notes:
<MQL = Less than the minimum quantification limit.
<MDL = Less than the minimum detection limit.
Presence of the compound confirmed by GC-MS/MS but at less than the defined quantification or detection limit for that compound using this method.

The third series of testing by LC-MS/MS multiresidue screen (Method ID: TOPS-142) was done to assess the presence of pesticides (as well as their content and identity) in the flesh of the bananas purchased. Table #3 provides a summary of the results from the testing.

TABLE #3
Results of testing of banana flesh for presence of pesticides using
a LC-MS/MS multiresidue screen (Method ID: TOPS-142)

| Sample | Test | Results |
|---|---|---|
| Banana #1 | Pesticide screen | Detected |
| Banana #1 | Fenpropimorph | <MQL |
| Banana #1 | Thiabendazole | 0.018 ppm |
| Banana #1 | Fenpropidin | <MDL |
| Banana #2 | Pesticide screen | Detected |
| Banana #2 | Pyriproxyfen | 0.0066 ppm |
| Banana #2 | Fenpropidin | <MDL |
| Banana #2 | Fenpropimorph | <MDL |
| Banana #3 | Pesticide screen | Detected |
| Banana #3 | Pyriproxyfen | 0.13 ppm |
| Banana #3 | Fenpropidin | <MDL |
| Banana #3 | Fenpropimorph | 0.018 ppm |
| Banana #3 | Pyrimethanil | <MDL |
| Banana #3 | Spiroxamine (isomer 1) | <MDL |
| Banana (organic #1) | Pesticide screen | Detected |
| Banana (organic #1) | Fenpropidin | <MDL |
| Banana (organic #1) | Fenpropimorph | 0.0037 ppm |
| Banana (organic #2) | Pesticide screen | Detected |
| Banana (organic #2) | Fenpropidin | <MQL |
| Banana (organic #2) | Fenpropimorph | <MQL |
| Banana (organic #3) | Pesticide screen | Detected |
| Banana (organic #3) | Fenpropidin | <MDL |
| Banana (organic #3) | Fenpropimorph | <MDL |

Notes:
<MQL = Less than the minimum quantification limit.
<MDL = Less than the minimum detection limit.

Presence of the compound confirmed by GC-MS/MS but at less than the defined quantification or detection limit for that compound using this method.

The testing data is a clear indication that despite all of the best efforts deployed, even bananas labelled ‘organic’ yield fruit which flesh contains pesticide residues. The above testing is proof that a residue-free product, such as a banana has still yet to be achieved on large monocultures as those are prone to infestations of insects, fungus, parasites or the like.

While the foregoing invention has been described in some detail for purposes of clarity and understanding, it will be appreciated by those skilled in the relevant arts, once they have been made familiar with this disclosure that various changes in form and detail can be made without departing from the true scope of the invention in the appended claims.

1. An antifungal composition comprising:
aqueous Hibiscus leaf extracts ranging in concentration from 2% to 40% w/vol.;
Karanja oil (pongamia oil) ranging in concentration from 0.01% to 30% w/vol, wherein said Karanja oil comprises Karanjin ranging in concentration from 0.001 to 3% w/vol. of said composition;
a natural surfactant; and
fermented aloe vera extracts present in an amount ranging from 40 to 60 wt % of the total weight of the composition.

2. The antifungal composition according to claim 1 where the Karanja oil is present in an amount ranging from 1 to 5 wt % of the total weight of the composition.

3. The aqueous fungicidal composition according to claim 1 further comprising the natural surfactant present in an amount ranging from 30 to 60 wt % of the total weight of the composition.

4. The aqueous fungicidal composition according to claim 1 further comprising at least one citrate component selected from the group consisting of: potassium citrate; aluminum citrate; diammonium citrate; ferric citrate; magnesium citrate; monosodium citrate; zinc citrate; citric acid; and other natural forms of citric acid, wherein the at least one citrate component ranges in concentration between 2% and 40% by w/vol.

5. The aqueous fungicidal composition according to claim 1 further comprising at least one acetate component selected from the group consisting of: ammonium acetate; potassium acetate; zinc acetate; aluminium acetate; acetic acid and combinations thereof, and wherein the at least one acetate component ranges in concentration between 2.5% to 90% w/vol of the composition.

6. The aqueous fungicidal composition according to claim 1 further comprising at least one propionate/propionic acid compound selected from the group consisting of: ammonium propionate; calcium propionate; magnesium propionate; potassium propionate; sodium propionate propionic acid and combinations thereof and wherein the at least one acetate propionate/propionic acid compound is present in a concentration ranging from 1% to 90% w/vol of the composition.

7. The aqueous fungicidal composition according to claim 1 further comprising tartaric acid or a salt thereof selected from the group consisting of: cream of tartar (potassium bitartrate); rochelle salt (potassium sodium tartrate); antimony potassium tartrate and tartaric acid and combinations thereof and wherein the tartaric acid or a salt thereof is present in a concentration ranging from 0.05% to 30% w/vol. of the composition.

8. The aqueous fungicidal composition according to claim 1 further comprising succinic acid or a derivative thereof such as sodium succinate (anhydrous) that is the disodium salt of succinic acid, and wherein the succinic acid or a derivative thereof is present in a concentration ranging from 0.02% to 10% w/vol of the composition.

9. The aqueous fungicidal composition according to claim 1 further comprising malic acid in a concentration ranging from 0.002% to 15% w/vol of the composition.

10. The aqueous fungicidal composition according to claim 1 further comprising a lactate component selected from the group consisting of: sodium lactate; calcium lactate; potassium lactate; and lactic acid, and wherein the lactate component is present in a concentration ranging from 1% to 90% w/vol of the composition.

11. The aqueous fungicidal composition according to claim 1 further comprising a combination of shikimic acid or ferulic acid or benzoic acids or their salts or esters and ranging in concentration from 0.05% to 30% w/vol of the composition.

12. The aqueous fungicidal composition according to claim 1 further comprising formic acid ranging in concentration from 0.05% to 30% w/vol of the composition.

13. Method for the prevention, treatment and/or management of the blight-related diseases in a cropprone to such disease, said method comprising the steps of:
providing a fungicidal composition comprising Karanja oil;
applying said composition on said plants;
wherein said step of applying is repeated as necessary and can be done until the day before harvest.

14. Method for the stimulation of the growth of a plant prone to blight-related diseases in a crop, said method comprising the steps of:
providing a fungicidal composition comprising Karanja oil;
applying said composition on said crop;
wherein said step of applying is repeated as necessary and can be done until the day before harvest.

15. The method according to claim 13, wherein said composition further comprises fermented aloe vera extracts.

16. The method according to claim 13, wherein said composition further comprises a natural surfactant.

17. The method according to claim 14, wherein said composition further comprises fermented aloe vera extracts.

18. The method according to claim 14, wherein said composition further comprises a natural surfactant.

19. An antifungal composition comprising:
aqueous Hibiscus leaf extracts ranging in concentration from 2% to 30% w/vol.;
Karanja oil (pongamia oil) ranging in concentration from 1 to 5% w/vol,
wherein said Karanja oil comprises Karanjin ranging in concentration from 0.01 to 3% w/vol. of said composition;
fermented aloe vera extracts present in an amount ranging from 2 to 20% w/vol; and
a citrate component selected from the group consisting of: potassium citrate; aluminium citrate;
diammonium citrate; ferric citrate; magnesium citrate; monosodium citrate; zinc citrate; and citric acid, present in a concentration ranging from 10 to 40%.

20. The antifungal composition according to claim 19 further comprising:
an antibacterial compound and a preservative compound.
